(19) United States
(12) Patent Application Publication
(10) Pub. No.: US 2019/0223461 A1
(43) Pub. Date: Jul. 25, 2019

(54) Production and Separation of Milk Fractions with Electrochemical Treatment

(71) Applicant: fairlife, LLC, Chicago, IL (US)

(72) Inventors: Shakeel Ur Rehman, Naperville, IL (US); Timothy P. Doelman, Glencoe, IL (US)

(21) Appl. No.: 16/188,535

(22) Filed: Nov. 13, 2018

Related U.S. Application Data
(60) Provisional application No. 62/620,509, filed on Jan. 23, 2018.

(51) Int. Cl. A23C 9/142; A23C 9/15

(52) U.S. Cl. CPC A23C 9/1422; A23C 9/1427; A23C 9/1512

(57) ABSTRACT

Disclosed are methods for preparing dairy compositions using an electrochemical separation process in combination with at least one of ultrafiltration, microfiltration, and nanofiltration. Additional methods for preparing the dairy compositions can further include a reverse osmosis step and/or a forward osmosis step.

### REFERENCE TO RELATED APPLICATION

This application claims the benefit of U.S. Provisional Application Ser. No. 62/620,509, filed on Jan. 23, 2018, the disclosure of which is incorporated herein by reference in its entirety.

### BACKGROUND OF THE INVENTION

The present invention relates generally to separating a milk product into protein, fat, carbohydrate, and mineral components using combinations of filtration, electrochemical, and osmosis techniques. Also encompassed are dairy compositions produced by mixing the milk components in various combinations and proportions.

### SUMMARY OF THE INVENTION

This summary is provided to introduce a selection of concepts in a simplified form that are further described herein. This summary is not intended to identify required or essential features of the claimed subject matter. Nor is this summary intended to be used to limit the scope of the claimed subject matter.

Consistent with embodiments of this invention, a first method for making a dairy composition is disclosed, and the first method can comprise (a) ultrafiltering a milk product to produce a UF permeate fraction and a UF retentate fraction, and (b) subjecting the UF permeate fraction to an electrochemical process to produce a lactose fraction, a positively charged fraction, and a negatively charged fraction. This first method can further comprise a step of (c) combining at least two of the UF retentate fraction, the lactose fraction, the positively charged fraction, the negatively charged fraction, and a fat-rich fraction to form the dairy composition. Alternatively, the first method can further comprise the steps of (c) subjecting the positively charged fraction, the negatively charged fraction, or a mixture thereof, to a reverse osmosis step to produce a concentrated mineral fraction and a milk water fraction, and (d) combining at least two of the UF retentate fraction, the lactose fraction, the concentrated mineral fraction, the milk water fraction, and a fat-rich fraction to form the dairy composition. Alternatively, the first method can further comprise the steps of (c) subjecting the positively charged fraction, the negatively charged fraction, or a mixture thereof, to a forward osmosis step to produce a mineral concentrate and water, and (d) combining at least two of the UF retentate fraction, the lactose fraction, the mineral concentrate, water, and a fat-rich fraction to form the dairy composition. Alternatively, the first method can further comprise the steps of (c) subjecting the positively charged fraction, the negatively charged fraction, or a mixture thereof, to a reverse osmosis step to produce a concentrated mineral fraction and a milk water fraction, (d) subjecting the concentrated mineral fraction to forward osmosis to produce a mineral concentrate and water, and (e) combining at least two of the UF retentate fraction, the lactose fraction, the mineral concentrate, the milk water fraction, water, and a fat-rich fraction to form the dairy composition.

A second method for making a dairy composition also is disclosed herein, and the second method can comprise (i) microfiltering a milk product to produce a MF permeate fraction and a MF retentate fraction, and (ii) subjecting the MF permeate fraction to an electrochemical process to produce a lactose fraction, a positively charged fraction, and a negatively charged fraction. This second method can further comprise a step of (iii) combining at least two of the MF retentate fraction, the lactose fraction, the positively charged fraction, the negatively charged fraction, and a fat-rich fraction to form the dairy composition. Alternatively, the second method can further comprise the steps of (iii) subjecting the positively charged fraction, the negatively charged fraction, or a mixture thereof, to a reverse osmosis step to produce a concentrated mineral fraction and a milk water fraction, and (iv) combining at least two of the MF retentate fraction, the lactose fraction, the concentrated mineral fraction, the milk water fraction, and a fat-rich fraction to form the dairy composition. Alternatively, the second method can further comprise the steps of (iii) subjecting the positively charged fraction, the negatively charged fraction, or a mixture thereof, to a forward osmosis step to produce a mineral concentrate and water, and (iv) combining at least two of the MF retentate fraction, the lactose fraction, the mineral concentrate, water, and a fat-rich fraction to form the dairy composition. Alternatively, the second method can further comprise the steps of (iii) subjecting the positively charged fraction, the negatively charged fraction, or a mixture thereof, to a reverse osmosis step to produce a concentrated mineral fraction and a milk water fraction, (iv) subjecting the concentrated mineral fraction to forward osmosis to produce a mineral concentrate and water, and (v) combining at least two of the MF retentate fraction, the lactose fraction, the mineral concentrate, the milk water fraction, water, and a fat-rich fraction to form the dairy composition.

A third method for making a dairy composition also is disclosed herein, and the third method can comprise (I) subjecting skim milk to a lactase enzyme treatment to produce a hydrolyzed skim milk product, (II) nanofiltering the hydrolyzed skim milk product to produce a NF permeate fraction and a NF retentate fraction, and (III) subjecting the NF permeate fraction to an electrochemical process to produce a glucose/galactose fraction, a positively charged fraction, and a negatively charged fraction. This third method can further comprise a step of (IV) combining at least two of the NF retentate fraction, the glucose/galactose fraction, the positively charged fraction, the negatively charged fraction, and a fat-rich fraction to form the dairy composition. Alternatively, the third method can further comprise the steps of (IV) subjecting the positively charged fraction, the negatively charged fraction, or a mixture thereof, to a reverse osmosis step to produce a concentrated mineral fraction and a milk water fraction, and (V) combining at least two of the NF retentate fraction, the glucose/galactose fraction, the concentrated mineral fraction, the milk water fraction, and a fat-rich fraction to form the dairy composition. Alternatively, the third method can further comprise the steps of (IV) subjecting the positively charged fraction, the negatively charged fraction, or a mixture thereof, to a forward osmosis step to produce a mineral concentrate and water, and (V) combining at least two of the NF retentate fraction, the glucose/galactose fraction, the mineral concentrate, water, and a fat-rich fraction to form the dairy composition. Alternatively, the third method can further comprise the steps of (IV) subjecting the positively charged fraction, the negatively charged fraction, or a mixture thereof, to a reverse osmosis step to produce a concentrated mineral fraction and a milk water fraction, (V) subjecting the concentrated mineral fraction to forward osmosis to produce a mineral concentrate and water, and (VI) combining at least two of the NF retentate fraction, the glucose/galactose fraction, the mineral concentrate, the milk water fraction, water, and a fat-rich fraction to form the dairy composition.

Both the foregoing summary and the following detailed description provide examples and are explanatory only. Accordingly, the foregoing summary and the following detailed description should not be considered to be restrictive. Further, features or variations can be provided in addition to those set forth herein. For example, certain embodiments can be directed to various feature combinations and sub-combinations described in the detailed description.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997), can be applied, as long as that definition does not conflict with any other disclosure or definition applied herein, or render indefinite or non-enabled any claim to which that definition can be applied. To the extent that any definition or usage provided by any document incorporated herein by reference conflicts with the definition or usage provided herein, the definition or usage provided herein controls.

Herein, features of the subject matter are described such that, within particular aspects and/or embodiments, a combination of different features can be envisioned. For each and every aspect, and/or embodiment, and/or feature disclosed herein, all combinations that do not detrimentally affect the designs, compositions, processes, and/or methods described herein are contemplated with or without explicit description of the particular combination. Additionally, unless explicitly recited otherwise, any aspect, and/or embodiment, and/or feature disclosed herein can be combined to describe inventive designs, compositions, processes, and/or methods consistent with the present invention.

In this disclosure, while compositions and processes are often described in terms of “comprising” various components or steps, the compositions and processes can also “consist essentially of” or “consist of” the various components or steps, unless stated otherwise. For example, a dairy composition consistent with embodiments of the present invention can comprise; alternatively, can consist essentially of; or alternatively, can consist of; a fat-rich fraction, a UF retentate fraction, and a concentrated mineral fraction.

The terms “a,” “an,” and “the” are intended to include plural alternatives, e.g., at least one, unless otherwise specified. For instance, the disclosure of “an ingredient” and “an additional milk fraction” are meant to encompass one, or mixtures or combinations of more than one, ingredient and additional milk fraction, unless otherwise specified.

In the disclosed processes, the term “combining” encompasses the contacting of components in any order, in any manner, and for any length of time, unless otherwise specified. For example, the components can be combined by blending or mixing.

The “lactose fraction” is meant to encompass a milk component fraction that is rich in lactose or any derivatives thereof, e.g., hydrolyzed, un-hydrolyzed, epimerized, isomerized, or converted to oligosaccharides, as would be recognized by one of skill in the art. Moreover, unless stated otherwise, this term also is meant to encompass glucose/galactose, such as may be produced by the treatment of lactose with lactase enzyme.

Although any methods and materials similar or equivalent to those described herein can be used in the practice or testing of the invention, the typical methods and materials are herein described.

Various numerical ranges are disclosed herein. When a range of any type is disclosed or claimed herein, the intent is to disclose or claim individually each possible number that such a range could reasonably encompass, including end points of the range as well as any sub-ranges and combinations of sub-ranges encompassed therein, unless otherwise specified. As a representative example, the present application discloses that a UF retentate fraction can have, in certain embodiments, from about 9 to about 15 wt. % protein. By a disclosure that the protein content of the UF retentate fraction can be in a range from about 9 to about 15 wt. %, the intent is to recite that the protein content can be any amount within the range and, for example, can be equal to about 9, about 10, about 11, about 12, about 13, about 14, or about 15 wt. %. Additionally, the UF retentate fraction can contain an amount of protein within any range from about 9 to about 15 wt. % (for example, from about 10 to about 14 wt. %), and this also includes any combination of ranges between about 9 and about 15 wt. %. Likewise, all other ranges disclosed herein should be interpreted in a manner similar to this example.

The term “about” means that amounts, sizes, formulations, parameters, and other quantities and characteristics are not and need not be exact, but may be approximate including being larger or smaller, as desired, reflecting tolerances, conversion factors, rounding off, measurement errors, and the like, and other factors known to those of skill in the art. In general, an amount, size, formulation, parameter or other quantity or characteristic is “about” or “approximate” whether or not expressly stated to be such. The term “about” also encompasses amounts that differ due to different equilibrium conditions for a composition resulting from a particular initial mixture. Whether or not modified by the term “about,” the claims include equivalents to the quantities. The term “about” can mean within 10% of the reported numerical value, preferably within 5% of the reported numerical value.

### DETAILED DESCRIPTION OF THE INVENTION

Methods for making dairy compositions are disclosed and described herein. Such methods can utilize an electrochemical separation process in combination with at least one of ultrafiltration, microfiltration, and nanofiltration. Methods for preparing the dairy compositions, in further embodiments consistent with this invention, also can include a reverse osmosis step and/or a forward osmosis step.

While not wishing to be bound by theory, it is believed that the methods disclosed herein can result in higher quality milk products with better operational efficiency and less waste. For instance, water components resulting from these methods can be substantially devoid of protein, fat, lactose (or other sugars), and minerals.

In accordance with an embodiment of this invention, a first method for making a dairy composition can comprise (or consist essentially of, or consist of) (a) ultrafiltering a milk product to produce a UF permeate fraction and a UF retentate fraction, and (b) subjecting the UF permeate fraction to an electrochemical process to produce a lactose fraction, a positively charged fraction, and a negatively charged fraction. This first method can further comprise a step of (c) combining at least two of the UF retentate fraction, the lactose fraction, the positively charged fraction, the negatively charged fraction, and a fat-rich fraction to form the dairy composition. Alternatively, the first method can further comprise the steps of (c) subjecting the positively charged fraction, the negatively charged fraction, or a mixture thereof, to a reverse osmosis step to produce a concentrated mineral fraction and a milk water fraction, and (d) combining at least two of the UF retentate fraction, the lactose fraction, the concentrated mineral fraction, the milk water fraction, and a fat-rich fraction to form the dairy composition. Alternatively, the first method can further comprise the steps of (c) subjecting the positively charged fraction, the negatively charged fraction, or a mixture thereof, to a forward osmosis step to produce a mineral concentrate and water, and (d) combining at least two of the UF retentate fraction, the lactose fraction, the mineral concentrate, water, and a fat-rich fraction to form the dairy composition. Alternatively, the first method can further comprise the steps of (c) subjecting the positively charged fraction, the negatively charged fraction, or a mixture thereof, to a reverse osmosis step to produce a concentrated mineral fraction and a milk water fraction, (d) subjecting the concentrated mineral fraction to forward osmosis to produce a mineral concentrate and water, and (e) combining at least two of the UF retentate fraction, the lactose fraction, the mineral concentrate, the milk water fraction, water, and a fat-rich fraction to form the dairy composition. Optionally, the UF retentate can be subjected to a step of diafiltering, which can result in a DF retentate fraction with reduced lactose content. Thus, in such circumstances, the DF retentate fraction can be used in the combining step to form the dairy composition.

In accordance with another embodiment of this invention, a second method for making a dairy composition can comprise (or consist essentially of, or consist of) (i) microfiltering a milk product to produce a MF permeate fraction and a MF retentate fraction, and (ii) subjecting the MF permeate fraction to an electrochemical process to produce a lactose fraction, a positively charged fraction, and a negatively charged fraction. This second method can further comprise a step of (iii) combining at least two of the MF retentate fraction, the lactose fraction, the positively charged fraction, the negatively charged fraction, and a fat-rich fraction to form the dairy composition. Alternatively, the second method can further comprise the steps of (iii) subjecting the positively charged fraction, the negatively charged fraction, or a mixture thereof, to a reverse osmosis step to produce a concentrated mineral fraction and a milk water fraction, and (iv) combining at least two of the MF retentate fraction, the lactose fraction, the concentrated mineral fraction, the milk water fraction, and a fat-rich fraction to form the dairy composition. Alternatively, the second method can further comprise the steps of (iii) subjecting the positively charged fraction, the negatively charged fraction, or a mixture thereof, to a forward osmosis step to produce a mineral concentrate and water, and (iv) combining at least two of the MF retentate fraction, the lactose fraction, the mineral concentrate, water, and a fat-rich fraction to form the dairy composition. Alternatively, the second method can further comprise the steps of (iii) subjecting the positively charged fraction, the negatively charged fraction, or a mixture thereof, to a reverse osmosis step to produce a concentrated mineral fraction and a milk water fraction, (iv) subjecting the concentrated mineral fraction to forward osmosis to produce a mineral concentrate and water, and (v) combining at least two of the MF retentate fraction, the lactose fraction, the mineral concentrate, the milk water fraction, water, and a fat-rich fraction to form the dairy composition. Optionally, the MF retentate can be subjected to a step of diafiltering, which can result in a DF fraction with reduced lactose content and increased casein protein content. Thus, in such circumstances, this DF fraction can be used in the combining step to form the dairy composition. Also optionally, the MF permeate can be subjected to a step of ultrafiltering, which can result in an increase in whey protein content, prior to the electrochemical treatment process.

In accordance with yet another embodiment of this invention, a third method for making a dairy composition can comprise (or consist essentially of, or consist of) (I) subjecting skim milk to a lactase enzyme treatment to produce a hydrolyzed skim milk product, (II) nanofiltering the hydrolyzed skim milk product to produce a NF permeate fraction and a NF retentate fraction, and (III) subjecting the NF permeate fraction to an electrochemical process to produce a glucose/galactose fraction, a positively charged fraction, and a negatively charged fraction. This third method can further comprise a step of (IV) combining at least two of the NF retentate fraction, the glucose/galactose fraction, the positively charged fraction, the negatively charged fraction, and a fat-rich fraction to form the dairy composition. Alternatively, the third method can further comprise the steps of (IV) subjecting the positively charged fraction, the negatively charged fraction, or a mixture thereof, to a reverse osmosis step to produce a concentrated mineral fraction and a milk water fraction, and (V) combining at least two of the NF retentate fraction, the glucose/galactose fraction, the concentrated mineral fraction, the milk water fraction, and a fat-rich fraction to form the dairy composition. Alternatively, the third method can further comprise the steps of (IV) subjecting the positively charged fraction, the negatively charged fraction, or a mixture thereof, to a forward osmosis step to produce a mineral concentrate and water, and (V) combining at least two of the NF retentate fraction, the glucose/galactose fraction, the mineral concentrate, water, and a fat-rich fraction to form the dairy composition. Alternatively, the third method can further comprise the steps of (IV) subjecting the positively charged fraction, the negatively charged fraction, or a mixture thereof, to a reverse osmosis step to produce a concentrated mineral fraction and a milk water fraction, (V) subjecting the concentrated mineral fraction to forward osmosis to produce a mineral concentrate and water, and (VI) combining at least two of the NF retentate fraction, the glucose/galactose fraction, the mineral concentrate, the milk water fraction, water, and a fat-rich fraction to form the dairy composition.

Generally, the features of these first, second, and third methods (e.g., the characteristics of the milk product, the ultrafiltering step and the resultant UF permeate fraction and UF retentate fraction, the microfiltering step and the resultant MF permeate fraction and MF retentate fraction, the nanofiltering step and the resultant NF permeate fraction and NF retentate fraction, the electrochemical step and the resultant lactose fraction (or glucose/galactose fraction), positively charged fraction, and negatively charged fraction, the reverse osmosis step and the resultant concentrated mineral fraction and milk water fraction, the forward osmosis step and the resultant mineral concentrate, and the components that are combined to form the dairy composition, among others) are independently described herein and these features can be combined in any combination to further describe the disclosed methods. Moreover, other process steps can be conducted before, during, and/or after any of the steps listed in the disclosed methods, unless stated otherwise. Additionally, any dairy compositions (e.g., finished milk products, ready for consumption) produced in accordance with any of the disclosed methods are within the scope of this disclosure and are encompassed herein.

Filtration technologies (e.g., ultrafiltration, microfiltration, nanofiltration, and reverse osmosis) can separate or concentrate components in mixtures—such as milk—by passing the mixture through a membrane system (or selective barrier) under a suitable conditions (e.g., pressure). The concentration/separation can be, therefore, based on molecular size. The stream that is retained by the membrane is called the retentate (or concentrate). The stream that passes through the pores of the membrane is called the permeate. Referring now to the first method for making a dairy composition, this method can comprise (a) ultrafiltering a milk product to produce a UF permeate fraction and a UF retentate fraction, and (b) subjecting the UF permeate fraction to an electrochemical process to produce a lactose fraction, a positively charged fraction, and a negatively charged fraction.

The milk product in step (a) can comprise (or consist essentially of, or consist of) skim milk, or alternatively, whole milk. In some embodiments, the first method can further comprise a step of separating (e.g., centrifugally separating) a raw milk or fresh milk into the milk product (also referred to as skim milk) and a fat-rich fraction (also referred to as cream or butter fat). The raw milk or fresh milk can be cow's milk, which contains approximately 87 wt. % water, 3-4 wt. % protein, 4-5 wt. % carbohydrates/lactose, 3-4 wt. % fat, and 0.3-0.8 wt. % minerals. When the fresh or raw milk product is separated into the skim milk product and the fat-rich fraction, the fat-rich fraction typically contains high levels of fat (e.g., 20-50 wt. % fat, or 30-50 wt. % fat) and solids (e.g., 30-60 wt. %, or 40-55 wt. %), and often contains approximately 1.5-3.5 wt. % protein, 2-5 wt. % lactose, and 0.2-0.9 wt. % minerals, although not limited thereto.

In step (a), ultrafiltering of the milk product can be conducted using ultrafiltration membranes with pore sizes that typically are in the 0.01 to 0.1 micron range. In the dairy industry, the ultrafiltration membranes often are identified based on molecular weight cut-off (MWCO), rather than pore size. The molecular weight cut-off for ultrafiltration membranes can vary from 1000-100,000 Daltons. For instance, the milk product can be ultrafiltered using a polymeric membrane system (ceramic membranes also can be employed). The polymeric membrane system can be configured with pore sizes such that the materials having molecular weights greater than about 1,000 Daltons, greater than about 5,000 Daltons, or greater than about 10,000 Daltons, are retained, while lower molecular weight species pass through. In some embodiments, the step of ultrafiltering utilizes a membrane system having pore sizes in a range from about 0.01 to about 0.1 μm, and operating pressures typically in the 45-150 psig range.

In step (b), the UF permeate fraction can be subjected to an electrochemical process to produce a lactose fraction, a positively charged fraction, and a negatively charged fraction. In an embodiment, the electrochemical process can comprise electrodialysis. In another embodiment, the electrochemical process can comprise electrochemical ion exchange; additional information is disclosed in U.S. Patent Publication No. 2016/0199784, which is incorporated herein by reference in its entirety.

This first method can further comprise a step of (c) combining at least two of the UF retentate fraction, the lactose fraction, the positively charged fraction, the negatively charged fraction, and a fat-rich fraction to form the dairy composition. Any combinations of these components can be mixed or combined, in any suitable relative proportions, to form the dairy composition. Moreover, an ingredient and/or an additional milk fraction also can be added in the combining step. Additionally or alternatively, an ingredient and/or an additional milk fraction can be added to the dairy composition after the combining step. Non-limiting examples of suitable ingredients can include a sugar/sweetener, a flavorant, a preservative (e.g., to prevent yeast or mold growth), a stabilizer, an emulsifier, a prebiotic substance, a special probiotic bacteria, a vitamin, a mineral, an omega 3 fatty acid, a phyto-sterol, an antioxidant, or a colorant, and the like, as well as any mixture or combination thereof.

The additional milk fraction can be a “component-rich fraction,” which is meant to encompass any fraction containing at least 15% more of a component of milk (protein, lactose/sugar, fat, minerals) than that found in cow's milk. For instance, a lactose-rich fraction often can contain from about 6 to about 20 wt. % sugar (i.e., in any form, such as lactose, glucose, galactose, etc.), from about 6 to about 18 wt. % sugar, or from about 7 to about 16 wt. % sugar. A mineral-rich fraction can contain from about 1 to about 20 wt. % minerals, from about 1 to about 10 wt. % minerals, or from about 1.5 to about 8 wt. % minerals. A fat-rich fraction often can contain from about 8 to about 50 wt. % fat, from about 20 to about 50 wt. % fat, or from about 30 to about 45 wt. % fat.

These component-rich milk fractions can be produced as described herein or by any technique known to those of skill in the art, such as by membrane filtration processes disclosed in U.S. Pat. Nos. 7,169,428, 9,510,606, and 9,538,770, which are incorporated herein by reference in their entirety. Additionally or alternatively, the component-rich milk fraction (or milk fractions) can be produced by a process comprising mixing water and a powder ingredient (e.g., protein powder, lactose powder, mineral powder, etc.).

Any suitable vessel and conditions can be used for any combining step disclosed herein, and such can be accomplished batchwise or continuously. As an example, the components can be combined in a suitable vessel (e.g., a tank, a silo, etc.) under atmospheric pressure, optionally with agitation or mixing, and optionally with an ingredient (or ingredients) and/or an additional milk fraction (or milk fractions), to form a batch of the finished dairy composition. As another example, the components can be combined continuously in a pipe or other suitable vessel under slight pressure (e.g., 5-50 psig), optionally mixed with ingredients and/or additional milk fractions, and the finished dairy composition can be transferred to a storage tank or filled into containers for retail distribution and sale. Representative systems that can be used for this continuous combining, mixing, and/or packaging can include tetra aldose systems and tetra flexidose systems. Other appropriate methods, systems, and apparatus for combining the components and other ingredients and/or milk fractions are readily apparent from this disclosure.

In one embodiment, for instance, step (c) can comprise combining the UF retentate fraction and the positively charged fraction and/or the negatively charged fraction, while in another embodiment, step (c) can comprise combining the fat-rich fraction, the UF retentate fraction, and the positively charged fraction and/or the negatively charged fraction. As described herein, these components can be combined in any suitable proportions, and optionally, an ingredient and/or additional milk fraction can added in step (c) to form the dairy composition.

In an alternative embodiment, the first method for making a dairy composition—after the ultrafiltering and electrochemical process steps—can further comprise the steps of (c) subjecting the positively charged fraction, the negatively charged fraction, or a mixture thereof, to a reverse osmosis step to produce a concentrated mineral fraction and a milk water fraction, and (d) combining at least two of the UF retentate fraction, the lactose fraction, the concentrated mineral fraction, the milk water fraction, and a fat-rich fraction to form the dairy composition.

Reverse osmosis is performed in step (c). Reverse osmosis is a tight filtration process in which substantially all the remaining milk components are retained (e.g., a concentrated mineral fraction), and only water (milk water) passes through. Generally, reverse osmosis comprises a membrane system having pore sizes of less than or equal to about 0.001 μm. Operating pressures typically are in the 450-1500 psig, or 450-600 psig, range. Temperatures ranging from about 5 to about 45° C., or from about 15 to about 45° C., often can used.

In step (d), at least two of the UF retentate fraction, the lactose fraction, the concentrated mineral fraction, the milk water fraction, and the fat-rich fraction can be combined to form the dairy composition. As described herein, any combinations of these components can be mixed or combined in any suitable relative proportions to form the dairy composition. Further, any suitable ingredient and/or additional milk fraction can added in the combining step; additionally or alternatively, any suitable ingredient and/or additional milk fraction can be added to the dairy composition after the combining step.

Thus, step (d) can comprise combining, at a minimum, the UF retentate fraction and the concentrated mineral fraction in one embodiment, and step (d) can comprise combining, at a minimum, the fat-rich fraction, the UF retentate fraction, and the concentrated mineral fraction in another embodiment.

In an alternative embodiment, the first method for making a dairy composition—after the ultrafiltering and electrochemical process steps—can further comprise the steps of (c) subjecting the positively charged fraction, the negatively charged fraction, or a mixture thereof, to a forward osmosis step to produce a mineral concentrate and water, and (d) combining at least two of the UF retentate fraction, the lactose fraction, the mineral concentrate, water, and a fat-rich fraction to form the dairy composition.

Forward osmosis is performed in step (c). Forward osmosis is typically performed at much lower pressures than reverse osmosis, and utilizes a semi-permeable membrane system having pore sizes such that water passes through, while other materials (e.g., proteins, fats, lactose or other sugars, and minerals) do not. Operating pressures typically are less than about 50 psig, and temperatures ranging from about 5 to about 50° C. often can used, while not being limited thereto. As compared to reverse osmosis, forward osmosis can achieve higher solids (e.g., often up to 40-60 wt. %), and is less susceptible to fouling.

In step (d), at least two of the UF retentate fraction, the lactose fraction, the mineral concentrate, water, and a fat-rich fraction can be combined to form the dairy composition. As described herein, any combinations of these components can be mixed or combined in any suitable relative proportions to form the dairy composition. Further, any suitable ingredient and/or additional milk fraction can added in the combining step; additionally or alternatively, any suitable ingredient and/or additional milk fraction can be added to the dairy composition after the combining step.

Thus, step (d) can comprise combining, at a minimum, the UF retentate fraction and the mineral concentrate in one embodiment, and step (d) can comprise combining, at a minimum, the fat-rich fraction, the UF retentate fraction, and the mineral concentrate in another embodiment.

In an alternative embodiment, the first method for making a dairy composition—after the ultrafiltering and electrochemical process steps—can further comprise the steps of (c) subjecting the positively charged fraction, the negatively charged fraction, or a mixture thereof, to a reverse osmosis step to produce a concentrated mineral fraction and a milk water fraction, (d) subjecting the concentrated mineral fraction to forward osmosis to produce a mineral concentrate and water, and (e) combining at least two of the UF retentate fraction, the lactose fraction, the mineral concentrate, the milk water fraction, water, and a fat-rich fraction to form the dairy composition.

In step (e), at least two of the UF retentate fraction, the lactose fraction, the mineral concentrate, the milk water fraction, water, and the fat-rich fraction can be combined to form the dairy composition. As described herein, any combinations of these components can be mixed or combined in any suitable relative proportions to form the dairy composition. Further, any suitable ingredient and/or additional milk fraction can added in the combining step; additionally or alternatively, any suitable ingredient and/or additional milk fraction can be added to the dairy composition after the combining step.

Thus, step (e) can comprise combining, at a minimum, the UF retentate fraction and the mineral concentrate in one embodiment, and step (e) can comprise combining, at a minimum, the fat-rich fraction, the UF retentate fraction, and the mineral concentrate in another embodiment.

Consistent with embodiments of this invention relating to the first method for making a dairy composition, the UF retentate fraction can be treated with lactase enzyme prior to the combining step, if desired. Likewise, if desired, the first method can further comprise a step of microfiltering the milk product prior to the ultrafiltering step, and/or the first method can further comprise a step of diafiltering after the ultrafiltering step, but before the electrochemical process.

While not being limited thereto, the protein content of the UF retentate fraction often can be at least about 5 wt. %, at least about 6 wt. %, at least about 7 wt. %, at least about 8 wt. %, or at least about 9 wt. % protein. Illustrative and non-limiting ranges for the protein content of the UF retentate can include from about 5 to about 20 wt. % protein, from about 6 to about 18 wt. % protein, or from about 9 to about 15 wt. % protein.

Similarly, while not being limited thereto, the lactose content of the UF permeate fraction and/or the UF retentate fraction generally can be less than or equal to about 7 wt. %, or less than or equal to about 6 wt. %, but greater than or equal to about 3 wt. %, or greater than or equal to about 4 wt. %. The lactose content of the lactose fraction can be at least about 6 wt. %, at least about 7 wt. %, at least about 8 wt. %, at least about 9 wt. %, or at least about 10 wt. % protein, but is not limited thereto. Illustrative and non-limiting ranges for the lactose content of the lactose fraction can include from about 6 to about 20 wt. %, from about 6 to about 18 wt. %, from about 7 to about 16 wt. %, from about 8 to about 18 wt. %, or from about 10 to about 16 wt. % lactose.

Referring now to the second method for making a dairy composition, this method can comprise (i) microfiltering a milk product to produce a MF permeate fraction and a MF retentate fraction, and (ii) subjecting the MF permeate fraction to an electrochemical process to produce a lactose fraction, a positively charged fraction, and a negatively charged fraction. The milk product in step (i) can be the same as that described hereinabove for the milk product in step (a) of the first method for making a dairy composition. For instance, the second method can further comprise a step of separating (e.g., centrifugally separating) a raw milk or fresh milk into the milk product (skim milk) and a fat-rich fraction (cream or butter fat).

In step (i), microfiltering of the milk product can be conducted using microfiltration membranes with pore sizes that typically are in the 0.1 to 10 micron range, for example, pore sizes in a range from about 0.1 to about 0.2 μm. In some embodiments, the step of microfiltering utilizes a membrane system having pore sizes in a range from about 0.1 to about 0.2 μm, with operating pressures typically less than about 75 psig and operating temperatures ranging from about 10 to about 60° C. (or from about 35 to about 55° C.), although not limited thereto.

In step (ii), the MF permeate fraction can be subjected to an electrochemical process to produce a lactose fraction, a positively charged fraction, and a negatively charged fraction. Step (ii) of the second method for making a dairy composition can be the same as that described hereinabove for step (b) of the first method for making a dairy composition. For instance, in one embodiment, the electrochemical process can comprise electrodialysis, while in another embodiment, the electrochemical process can comprise electrochemical ion exchange, as described in U.S. Patent Publication No. 2016/0199784.

This second method can further comprise a step of (iii) combining at least two of the MF retentate fraction, the lactose fraction, the positively charged fraction, the negatively charged fraction, and a fat-rich fraction to form the dairy composition. Any combinations of these components can be mixed or combined, in any suitable relative proportions, to form the dairy composition. Moreover, an ingredient and/or an additional milk fraction also can be added in the combining step. Additionally or alternatively, an ingredient and/or an additional milk fraction can be added to the dairy composition after the combining step. Representative examples of suitable ingredients and suitable additional milk fractions are disclosed hereinabove (e.g., in relation to the first method for making a dairy compositions) and can be utilized without limitation in the second method for making a dairy composition.

In one embodiment, for instance, step (iii) can comprise combining the MF retentate fraction and the positively charged fraction and/or the negatively charged fraction, while in another embodiment, step (iii) can comprise combining the fat-rich fraction, the MF retentate fraction, and the positively charged fraction and/or the negatively charged fraction. As described herein, these components can be combined in any suitable proportions, and optionally, an ingredient and/or additional milk fraction can added in step (iii) to form the dairy composition.

In an alternative embodiment, the second method for making a dairy composition—after the microfiltering and electrochemical process steps—can further comprise the steps of (iii) subjecting the positively charged fraction, the negatively charged fraction, or a mixture thereof, to a reverse osmosis step to produce a concentrated mineral fraction and a milk water fraction, and (iv) combining at least two of the MF retentate fraction, the lactose fraction, the concentrated mineral fraction, the milk water fraction, and a fat-rich fraction to form the dairy composition.

Reverse osmosis can be performed in step (iii) of the second method for making a dairy composition, and it can be performed in the same manner as reverse osmosis step (c) of the first method for making a dairy composition.

In step (iv), at least two of the MF retentate fraction, the lactose fraction, the concentrated mineral fraction, the milk water fraction, and the fat-rich fraction can be combined to form the dairy composition. As described herein, any combinations of these components can be mixed or combined in any suitable relative proportions to form the dairy composition. Further, any suitable ingredient and/or additional milk fraction can added in the combining step; additionally or alternatively, any suitable ingredient and/or additional milk fraction can be added to the dairy composition after the combining step.

Thus, step (iv) can comprise combining, at a minimum, the MF retentate fraction and the concentrated mineral fraction in one embodiment, and step (iv) can comprise combining, at a minimum, the fat-rich fraction, the MF retentate fraction, and the concentrated mineral fraction in another embodiment.

In an alternative embodiment, the second method for making a dairy composition—after the microfiltering and electrochemical process steps—can further comprise the steps of (iii) subjecting the positively charged fraction, the negatively charged fraction, or a mixture thereof, to a forward osmosis step to produce a mineral concentrate and water, and (iv) combining at least two of the MF retentate fraction, the lactose fraction, the mineral concentrate, water, and a fat-rich fraction to form the dairy composition.

Forward osmosis can be performed in step (iii) of the second method for making a dairy composition, and it can be performed in the same manner as forward osmosis step (c) of the first method for making a dairy composition.

In step (iv), at least two of the MF retentate fraction, the lactose fraction, the mineral concentrate, water, and a fat-rich fraction can be combined to form the dairy composition. As described herein, any combinations of these components can be mixed or combined in any suitable relative proportions to form the dairy composition. Further, any suitable ingredient and/or additional milk fraction can added in the combining step; additionally or alternatively, any suitable ingredient and/or additional milk fraction can be added to the dairy composition after the combining step.

Thus, step (iv) can comprise combining, at a minimum, the MF retentate fraction and the mineral concentrate in one embodiment, and step (d) can comprise combining, at a minimum, the fat-rich fraction, the MF retentate fraction, and the mineral concentrate in another embodiment.

In an alternative embodiment, the second method for making a dairy composition—after the microfiltering and electrochemical process steps—can further comprise the steps of (iii) subjecting the positively charged fraction, the negatively charged fraction, or a mixture thereof, to a reverse osmosis step to produce a concentrated mineral fraction and a milk water fraction, (iv) subjecting the concentrated mineral fraction to forward osmosis to produce a mineral concentrate and water, and (v) combining at least two of the MF retentate fraction, the lactose fraction, the mineral concentrate, the milk water fraction, water, and a fat-rich fraction to form the dairy composition.

In step (v), at least two of the MF retentate fraction, the lactose fraction, the mineral concentrate, the milk water fraction, water, and the fat-rich fraction can be combined to form the dairy composition. As described herein, any combinations of these components can be mixed or combined in any suitable relative proportions to form the dairy composition. Further, any suitable ingredient and/or additional milk fraction can added in the combining step; additionally or alternatively, any suitable ingredient and/or additional milk fraction can be added to the dairy composition after the combining step.

Thus, step (v) can comprise combining, at a minimum, the MF retentate fraction and the mineral concentrate in one embodiment, and step (v) can comprise combining, at a minimum, the fat-rich fraction, the UF retentate fraction, and the mineral concentrate in another embodiment.

Consistent with embodiments of this invention relating to the second method for making a dairy composition, the MF retentate fraction can be treated with lactase enzyme prior to the combining step, if desired.

While not being limited thereto, the casein protein content of the MF retentate fraction often can be at least about 5 wt. %, at least about 6 wt. %, at least about 7 wt. %, at least about 8 wt. %, or at least about 10 wt. % casein protein. Illustrative and non-limiting ranges for the casein protein content of the MF retentate can include from about 8 to about 25 wt. % casein protein, from about 10 to about 20 wt. % casein protein, or from about 8 to about 18 wt. % casein protein.

Similarly, while not being limited thereto, the lactose content of the MF permeate fraction and/or the MF retentate fraction generally can be less than or equal to about 7 wt. %, or less than or equal to about 6 wt. %, but greater than or equal to about 3 wt. %, or greater than or equal to about 4 wt. %. The lactose content of the lactose fraction can be at least about 6 wt. %, at least about 7 wt. %, at least about 8 wt. %, at least about 9 wt. %, or at least about 10 wt. % protein, but is not limited thereto. Illustrative and non-limiting ranges for the lactose content of the lactose fraction can include from about 6 to about 20 wt. %, from about 6 to about 18 wt. %, from about 7 to about 16 wt. %, from about 8 to about 18 wt. %, or from about 10 to about 16 wt. % lactose.

Referring now to the third method for making a dairy composition, this method can comprise (I) subjecting skim milk to a lactase enzyme treatment to produce a hydrolyzed skim milk product, (II) nanofiltering the hydrolyzed skim milk product to produce a NF permeate fraction and a NF retentate fraction, and (III) subjecting the NF permeate fraction to an electrochemical process to produce a glucose/galactose fraction, a positively charged fraction, and a negatively charged fraction. This third method can further comprise a step of separating (e.g., centrifugally separating) a raw milk or fresh milk into the skim milk and a fat-rich fraction (cream or butter fat).

In step (I), the skim milk can be contacted or combined with lactase enzyme to convert the lactose in the skim milk to glucose/galactose in the hydrolyzed skim milk product. In step (II), nanofiltering of the milk product can be conducted using nanofiltration membranes with pore sizes that typically are in the 0.001 to 0.01 micron range, for example, pore sizes in a range from about 0.001 to about 0.008 μm. In some embodiments, the step of microfiltering utilizes a membrane system having pore sizes in a range from 0.001 to about 0.01 μm, with operating pressures typically in the 150-450 psig range, and operating temperatures ranging from about 10 to about 60° C. (or from about 15 to about 45° C.), although not limited thereto.

In step (III), the NF permeate fraction can be subjected to an electrochemical process to produce a glucose/galactose fraction, a positively charged fraction, and a negatively charged fraction. Step (III) of the third method for making a dairy composition can be the same as that described hereinabove for step (b) of the first method for making a dairy composition. For instance, in one embodiment, the electrochemical process can comprise electrodialysis, while in another embodiment, the electrochemical process can comprise electrochemical ion exchange, as described in U.S. Patent Publication No. 2016/0199784.

This third method can further comprise a step of (IV) combining at least two of the NF retentate fraction, the glucose/galactose fraction, the positively charged fraction, the negatively charged fraction, and a fat-rich fraction to form the dairy composition. Any combinations of these components can be mixed or combined, in any suitable relative proportions, to form the dairy composition. Moreover, an ingredient and/or an additional milk fraction also can be added in the combining step. Additionally or alternatively, an ingredient and/or an additional milk fraction can be added to the dairy composition after the combining step. Representative examples of suitable ingredients and suitable additional milk fractions are disclosed hereinabove (e.g., in relation to the first method for making a dairy compositions) and can be utilized without limitation in the third method for making a dairy composition.

In one embodiment, for instance, step (IV) can comprise combining the NF retentate fraction and the positively charged fraction and/or the negatively charged fraction, while in another embodiment, step (IV) can comprise combining the fat-rich fraction, the NF retentate fraction, and the positively charged fraction and/or the negatively charged fraction. As described herein, these components can be combined in any suitable proportions, and optionally, an ingredient and/or additional milk fraction can added in step (IV) to form the dairy composition.

In an alternative embodiment, the third method for making a dairy composition (after steps (I)-(III) described hereinabove) can further comprise the steps of (IV) subjecting the positively charged fraction, the negatively charged fraction, or a mixture thereof, to a reverse osmosis step to produce a concentrated mineral fraction and a milk water fraction, and (V) combining at least two of the NF retentate fraction, the glucose/galactose fraction, the concentrated mineral fraction, the milk water fraction, and a fat-rich fraction to form the dairy composition.

Reverse osmosis can be performed in step (IV) of the third method for making a dairy composition, and it can be performed in the same manner as reverse osmosis step (c) of the first method for making a dairy composition.

In step (V), at least two of the NF retentate fraction, the glucose/galactose fraction, the concentrated mineral fraction, the milk water fraction, and the fat-rich fraction can be combined to form the dairy composition. As described herein, any combinations of these components can be mixed or combined in any suitable relative proportions to form the dairy composition. Further, any suitable ingredient and/or additional milk fraction can added in the combining step; additionally or alternatively, any suitable ingredient and/or additional milk fraction can be added to the dairy composition after the combining step.

Thus, step (V) can comprise combining, at a minimum, the NF retentate fraction and the concentrated mineral fraction in one embodiment, and step (V) can comprise combining, at a minimum, the fat-rich fraction, the NF retentate fraction, and the concentrated mineral fraction in another embodiment.

In an alternative embodiment, the third method for making a dairy composition (after steps (I)-(III) described hereinabove) can further comprise the steps of (IV) subjecting the positively charged fraction, the negatively charged fraction, or a mixture thereof, to a forward osmosis step to produce a mineral concentrate and water, and (V) combining at least two of the NF retentate fraction, the glucose/galactose fraction, the mineral concentrate, water, and a fat-rich fraction to form the dairy composition.

Forward osmosis can be performed in step (IV) of the third method for making a dairy composition, and it can be performed in the same manner as forward osmosis step (c) of the first method for making a dairy composition.

In step (V), at least two of the NF retentate fraction, the glucose/galactose fraction, the mineral concentrate, water, and a fat-rich fraction can be combined to form the dairy composition. As described herein, any combinations of these components can be mixed or combined in any suitable relative proportions to form the dairy composition. Further, any suitable ingredient and/or additional milk fraction can added in the combining step; additionally or alternatively, any suitable ingredient and/or additional milk fraction can be added to the dairy composition after the combining step.

Thus, step (V) can comprise combining, at a minimum, the NF retentate fraction and the mineral concentrate in one embodiment, and step (V) can comprise combining, at a minimum, the fat-rich fraction, the NF retentate fraction, and the mineral concentrate in another embodiment.

In an alternative embodiment, third method for making a dairy composition (after steps (I)-(III) described hereinabove) can further comprise the steps of (IV) subjecting the positively charged fraction, the negatively charged fraction, or a mixture thereof, to a reverse osmosis step to produce a concentrated mineral fraction and a milk water fraction, (V) subjecting the concentrated mineral fraction to forward osmosis to produce a mineral concentrate and water, and (VI) combining at least two of the NF retentate fraction, the glucose/galactose fraction, the mineral concentrate, the milk water fraction, water, and a fat-rich fraction to form the dairy composition.

In step (VI), at least two of the NF retentate fraction, the glucose/galactose fraction, the mineral concentrate, the milk water fraction, water, and the fat-rich fraction can be combined to form the dairy composition. As described herein, any combinations of these components can be mixed or combined in any suitable relative proportions to form the dairy composition. Further, any suitable ingredient and/or additional milk fraction can added in the combining step; additionally or alternatively, any suitable ingredient and/or additional milk fraction can be added to the dairy composition after the combining step.

Thus, step (VI) can comprise combining, at a minimum, the NF retentate fraction and the mineral concentrate in one embodiment, and step (VI) can comprise combining, at a minimum, the fat-rich fraction, the NF retentate fraction, and the mineral concentrate in another embodiment.

While not being limited thereto, the protein content of the NF retentate fraction often can be at least about 5 wt. %, at least about 6 wt. %, at least about 7 wt. %, at least about 8 wt. %, or at least about 9 wt. % protein. Illustrative and non-limiting ranges for the protein content of the NF retentate can include from about 5 to about 20 wt. % protein, from about 6 to about 18 wt. % protein, or from about 9 to about 15 wt. % protein.

Similarly, while not being limited thereto, the lactose content of the NF permeate fraction and/or the NF retentate fraction generally can be less than or equal to about 1 wt. %, less than or equal to about 0.5 wt. %, or less than or equal to about 0.25 wt. %. The glucose/galactose content (in total) of the glucose/galactose fraction can be at least about 6 wt. %, at least about 7 wt. %, at least about 8 wt. %, at least about 9 wt. %, or at least about 10 wt. % glucose/galactose, but is not limited thereto. Illustrative and non-limiting ranges for the glucose/galactose content of the glucose/galactose fraction can include from about 6 to about 20 wt. %, from about 6 to about 18 wt. %, from about 7 to about 16 wt. %, from about 8 to about 18 wt. %, or from about 10 to about 16 wt. % lactose.

Consistent with embodiments of the first, second, and third methods for making a dairy composition disclosed herein, these methods can further comprise a step of treating the respective dairy composition with lactase enzyme, if desired.

Moreover, these methods also can further comprise a step of heat treating the dairy composition. In one embodiment, the step of heat treating can comprise pasteurizing at a temperature in a range from about 80° C. to about 95° C. for a time period in a range from about 2 to about 15 minutes. In another embodiment, the step of heat treating can comprise UHT sterilization at a temperature in a range from about 135° C. to about 145° C. for a time period in a range from about 1 to about 10 seconds. Other appropriate pasteurization or sterilization temperature and time conditions are readily apparent from this disclosure. Further, this invention is not limited by the method or equipment used for performing the pasteurization/sterilization process—any suitable technique and apparatus can be employed, whether operated batchwise or continuously.

In some embodiments of this invention, the first, second, and third methods for making a dairy composition can further comprise a step of packaging (aseptically or otherwise) the dairy composition in any suitable container and under any suitable conditions. Thus, after combining the various components, ingredients, and additional milk fractions as described herein to form the dairy composition, the dairy composition can be packaged under aseptic conditions (or non-aseptic conditions) in a container. Any suitable container can be used, such as might be used for the distribution and/or sale of dairy products in a retail outlet. Illustrative and non-limiting examples of typical containers include a cup, a bottle, a bag, or a pouch, and the like. The container can be made from any suitable material, such as glass, metal, plastics, and the like, as well as combinations thereof.

Consistent with embodiments of the first, second, and third methods for making a dairy composition disclosed herein, the positively charged fraction and/or the negatively charged fraction, independently, can contain less than or equal to about 0.7 wt. % lactose and at least about 0.2 wt. % (or at least about 0.4 wt. %) minerals. Similarly, the concentrated mineral fraction can contain less than or equal to about 0.2 wt. % lactose, and at least about 0.5 wt. % minerals. Likewise, the mineral concentrate can comprise less than or equal to about 0.2 wt. % lactose, and at least about 1 wt. % minerals. In contrast, the milk water fraction can contain less than or equal to about 0.1 wt. % lactose, and less than or equal to about 0.1 wt. % minerals, but at least about 95 wt. % water, at least about 98 wt. % water, at least about 99 wt. % water, or at least about 99.5 wt. % water.

While not being limited thereto, the dairy composition can have a protein content of from about 1 to about 15 wt. %, or from about 3 to about 10 wt. %. Additionally or alternatively, the dairy composition can have a fat content of from about 0.05 to about 10 wt. %, or from about 0.1 to about 5 wt. %. Additionally or alternatively, the dairy composition can have a mineral content of from about 0.5 to about 2 wt. %. Additionally or alternatively, the dairy composition can have a lactose content of less than or equal to about 4 wt. %.

A representative and non-limiting example of a dairy composition consistent with this invention can contain from about 1 to about 3 wt. % fat, from about 2.5 to about 5.5 wt. % protein, from about 0.5 to about 1 wt. % minerals, and from about 1 to about 3 wt. % lactose.

Another representative and non-limiting example of a dairy composition consistent with this invention can contain from about 0.1 to about 0.3 wt. % fat, from about 6 to about 9 wt. % protein, from about 1 to about 2 wt. % minerals, and from about 2 to about 5 wt. % lactose.

Additional non-limiting examples of typical dairy compositions that can be produced by the methods disclosed herein include whole milk, low-fat milk, skim milk, buttermilk, flavored milk, low lactose milk, high protein milk, lactose-free milk, ultra-filtered milk, micro-filtered milk, concentrated milk, evaporated milk, high protein, high calcium, and reduced sugar milk, and the like.

### Examples

The invention is further illustrated by the following examples, which are not to be construed in any way as imposing limitations to the scope of this invention. Various other aspects, embodiments, modifications, and equivalents thereof which, after reading the description herein, can suggest themselves to one of ordinary skill in the art without departing from the spirit of the present invention or the scope of the appended claims.

### Constructive Example 1

In Constructive Example 1, a skim milk product can be subjected to an ultrafiltration step to produce a UF permeate fraction and a UF retentate fraction, having the respective compositions shown in the table below. The UF permeate fraction then can be subjected to an electrochemical process (such as electrochemical ion exchange) to produce a lactose fraction, a positively charged fraction, and a negatively charged fraction. The positively charged fraction and the negatively charged fraction can be combined to form a mineral stream. The expected compositions, respectively, of the lactose fraction and the mineral stream also are provided in the table below. Of particular interest, the lactose fraction has a minimal amount of minerals, whereas the mineral stream is free of lactose and protein.

| | Total solids | Fat | Protein | Lactose | Minerals |
|---|---|---|---|---|---|
| | (wt. %) | (wt. %) | (wt. %) | (wt. %) | (wt. %) |
| UF retentate | 19.53 | 0.30 | 12.60 | 4.88 | 1.40 |
| UF permeate | 5.55 | 0.11 | 0.22 | 4.48 | 0.54 |
| Lactose fraction | 5.12 | — | 0.22 | 4.48 | 0.11 |
| Mineral stream | 0.45 | — | 0.0 | 0.0 | 0.45 |

### Constructive Example 2

In Constructive Example 2, a UF permeate can be subjected to a nanofiltration step to produce a NF retentate fraction, having the respective compositions shown in the table below. The NF retentate fraction then can be subjected to an electrochemical process (such as electrochemical ion exchange) to produce a lactose fraction, a positively charged fraction, and a negatively charged fraction. The positively charged fraction and the negatively charged fraction can be combined to form a mineral stream. The expected compositions, respectively, of the lactose fraction and the mineral stream also are provided in the table below. Of particular interest, the lactose fraction has a minimal amount of minerals, whereas the mineral stream is free of lactose and protein.

| | Total solids | Fat | Protein | Lactose | Minerals |
|---|---|---|---|---|---|
| | (wt. %) | (wt. %) | (wt. %) | (wt. %) | (wt. %) |
| UF permeate | 5.55 | 0.11 | 0.22 | 4.48 | 0.54 |
| NF retentate | 12.93 | — | 0.08 | 12.0 | 0.85 |
| Lactose fraction | 12.25 | — | 0.08 | 12.0 | 0.17 |
| Mineral stream | 0.65 | — | 0.00 | 0.0 | 0.65 |

### Constructive Example 3

In Constructive Example 3, an incoming stream containing hard water and sugar (sucrose) can be subjected to an electrochemical process (such as electrochemical ion exchange) to produce a sugar (sucrose) fraction, a positively charged fraction, and a negatively charged fraction. The positively charged fraction and the negatively charged fraction can be combined to form a mineral stream. The expected compositions, respectively, of the incoming stream (hard water and sugar), the sugar (sucrose) fraction, and the mineral stream are provided in the table below. Of particular interest, the sugar (sucrose) fraction has a minimal amount of minerals, whereas the mineral stream is free of sugar (sucrose).

| | Total solids | Fat | Protein | Sugar | Minerals |
|---|---|---|---|---|---|
| Ingredient | (wt. %) | (wt. %) | (wt. %) | (wt. %) | (wt. %) |
| Hard water | 5.0 | 0.0 | 0.0 | 4.7 | 0.12 |
| with sugar | | | | | |
| Sugar fraction | 5.0 | 0.0 | 0.0 | 4.7 | 0.024 |
| Mineral stream | 0.096 | 0.0 | 0.0 | 0.0 | 0.096 |

We claim:

1. A method for making a dairy composition, the method comprising:
(a) ultrafiltering a milk product to produce a UF permeate fraction and a UF retentate fraction; and
(b) subjecting the UF permeate fraction to an electrochemical process to produce a lactose fraction, a positively charged fraction, and a negatively charged fraction.

2. The method of claim 1, further comprising:
(c) combining at least two of the UF retentate fraction, the lactose fraction, the positively charged fraction, the negatively charged fraction, and a fat-rich fraction to form the dairy composition.

3. The method of claim 1, further comprising:
(c) subjecting the positively charged fraction, the negatively charged fraction, or a mixture thereof, to a reverse osmosis step to produce a concentrated mineral fraction and a milk water fraction; and
(d) combining at least two of the UF retentate fraction, the lactose fraction, the concentrated mineral fraction, the milk water fraction, and a fat-rich fraction to form the dairy composition.

4. The method of claim 1, further comprising:
(c) subjecting the positively charged fraction, the negatively charged fraction, or a mixture thereof, to a forward osmosis step to produce a mineral concentrate and water; and
(d) combining at least two of the UF retentate fraction, the lactose fraction, the mineral concentrate, water, and a fat-rich fraction to form the dairy composition.

5. The method of claim 1, further comprising:
(c) subjecting the positively charged fraction, the negatively charged fraction, or a mixture thereof, to a reverse osmosis step to produce a concentrated mineral fraction and a milk water fraction;
(d) subjecting the concentrated mineral fraction to forward osmosis to produce a mineral concentrate and water; and
(e) combining at least two of the UF retentate fraction, the lactose fraction, the mineral concentrate, the milk water fraction, water, and a fat-rich fraction to form the dairy composition.

6. The method of claim 1, wherein the electrochemical process comprises electrodialysis.

7. The method of claim 1, wherein the electrochemical process comprises electrochemical ion exchange.

8. The method of claim 1, wherein the positively charged fraction and/or the negatively charged fraction comprise(s):
less than or equal to about 0.7 wt. % lactose; and
at least about 0.2 wt. % minerals.

9. A method for making a dairy composition, the method comprising:
(i) microfiltering a milk product to produce a MF permeate fraction and a MF retentate fraction; and
(ii) subjecting the MF permeate fraction to an electrochemical process to produce a lactose fraction, a positively charged fraction, and a negatively charged fraction.

10. The method of claim 9, further comprising:
(iii) combining at least two of the MF retentate fraction, the lactose fraction, the positively charged fraction, the negatively charged fraction, and a fat-rich fraction to form the dairy composition.

11. The method of claim 9, further comprising:
(iii) subjecting the positively charged fraction, the negatively charged fraction, or a mixture thereof, to a reverse osmosis step to produce a concentrated mineral fraction and a milk water fraction; and
(iv) combining at least two of the MF retentate fraction, the lactose fraction, the concentrated mineral fraction, the milk water fraction, and a fat-rich fraction to form the dairy composition.

12. The method of claim 9, further comprising:
(iii) subjecting the positively charged fraction, the negatively charged fraction, or a mixture thereof, to a forward osmosis step to produce a mineral concentrate and water; and
(iv) combining at least two of the MF retentate fraction, the lactose fraction, the mineral concentrate, water, and a fat-rich fraction to form the dairy composition.

13. The method of claim 9, further comprising:
(iii) subjecting the positively charged fraction, the negatively charged fraction, or a mixture thereof, to a reverse osmosis step to produce a concentrated mineral fraction and a milk water fraction;
(iv) subjecting the concentrated mineral fraction to forward osmosis to produce a mineral concentrate and water; and
(v) combining at least two of the MF retentate fraction, the lactose fraction, the mineral concentrate, the milk water fraction, water, and a fat-rich fraction to form the dairy composition.

14. The method claim 9, wherein:
a lactose content of the MF permeate fraction and/or the MF retentate fraction is from about 4 wt. % to about 6 wt. %;
a lactose content of the lactose fraction is at least about 10 wt. %; and
a casein protein content of the MF retentate fraction is at least about 9 wt. %.

15. A method for making a dairy composition, the method comprising:
(I) subjecting skim milk to a lactase enzyme treatment to produce a hydrolyzed skim milk product;
(II) nanofiltering the hydrolyzed skim milk product to produce a NF permeate fraction and a NF retentate fraction; and
(III) subjecting the NF permeate fraction to an electrochemical process to produce a glucose/galactose fraction, a positively charged fraction, and a negatively charged fraction.

16. The method of claim 15, further comprising:
(IV) combining at least two of the NF retentate fraction, the glucose/galactose fraction, the positively charged fraction, the negatively charged fraction, and a fat-rich fraction to form the dairy composition.

17. The method of claim 15, further comprising:
(IV) subjecting the positively charged fraction, the negatively charged fraction, or a mixture thereof, to a reverse osmosis step to produce a concentrated mineral fraction and a milk water fraction; and
(V) combining at least two of the NF retentate fraction, the glucose/galactose fraction, the concentrated mineral fraction, the milk water fraction, and a fat-rich fraction to form the dairy composition.

18. The method of claim 15, further comprising:
(IV) subjecting the positively charged fraction, the negatively charged fraction, or a mixture thereof, to a forward osmosis step to produce a mineral concentrate and water; and
(V) combining at least two of the NF retentate fraction, the glucose/galactose fraction, the mineral concentrate, water, and a fat-rich fraction to form the dairy composition.

19. The method of claim 15, further comprising:
(IV) subjecting the positively charged fraction, the negatively charged fraction, or a mixture thereof, to a reverse osmosis step to produce a concentrated mineral fraction and a milk water fraction;
(V) subjecting the concentrated mineral fraction to forward osmosis to produce a mineral concentrate and water; and
(VI) combining at least two of the NF retentate fraction, the glucose/galactose fraction, the mineral concentrate, the milk water fraction, water, and a fat-rich fraction to form the dairy composition.

20. The method of claim 15, wherein the electrochemical process comprises electrochemical ion exchange.
